(19) United States
(12) Patent Application Publication
(10) Pub. No.: US 2007/0149177 A1
(43) Pub. Date: Jun. 28, 2007

(54) Mobile terminal

(76) Inventor: Osamu Uchida, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/582,155

(22) PCT Filed: Jan. 14, 2005
(86) PCT No.: PCT/JP05/00364

§ 371 Date: Jun. 8, 2006

(30) Foreign Application Priority Data
Jan. 15, 2004 (JP) 2004-007972

(51) Int. Cl. H04Q 7/38; H04Q 7/22; H04M 3/42

(52) U.S. Cl. 455/414.1

(57) ABSTRACT

A mobile terminal capable of setting easily the contents executably is provided. A directory file acquiring portion 19 detects that a removable medium 100 is fitted and then reads data recorded therein, and a directory name concurrence deciding/each content setting portion 20 decides whether or not a directory having a directory name ¥RD_THEME is present and then reads a contents file when the directory of ¥RD_THEME is present. Then, a wallpaper display setting/executing portion 11, a character display setting/executing portion 12, a standby application setting/executing portion 13, a menu icon display setting/executing portion 14, and a ringing tone sounding setting/executing portion 15 set each contents file executably based on the extension.

### TECHNICAL FIELD

The present invention relates to a mobile terminal capable of executing the contents.

### BACKGROUND ART

In recent years, the cellular phone capable of setting various contents such as a character setting, a standby Java (registered trademark, Sun Microsystems, Inc. in the USA) application, a menu icon, and the like, in addition to a wallpaper and a ringtone melody has been developed on account of the progress of multifunction of the cellular phone. These contents can be downloaded via the Internet or the mobile phone network.

At this time, when the user gets newly the contents via the cellular phone, such user must set manually each contents. In such case, the setting operations are troublesome and much time is consumed. Therefore, the mobile terminal capable of changing all contents collectively has been proposed (see Patent Literature 1, for example). Because all contents can be changed collectively, the user is free from complicated operations, which makes it possible to spread further the use of contents. In the mobile terminal disclosed in Patent Literature 1, a setting file in which plural types of contents are stored is acquired and then current contents are changed as a whole based on the contents stored in this setting file.

Patent Literature 1: JP-A-2002-118638 (page 3, page 4, FIG. 4)

### DISCLOSURE OF THE INVENTION

### Problems that the Invention is to Solve

However, in the conventional mobile terminal disclosed in Patent Literature 1, the user must operate the mobile terminal to set a desired setting file in its executable state. In this manner, in the conventional mobile terminal disclosed in Patent Literature 1, proportionate operations are needed to change the contents such as the wallpaper, the character setting, the standby Java application, the menu icon, the ringtone melody, and the like. Thus, in the case of the small-sized mobile terminal, sometimes the user is particularly hard to operate such mobile terminal.

The present invention has been made in view of above circumstances, and it is an object of the present invention to provide a mobile terminal capable of setting easily the contents in its executable state.

### Means for Solving the Problem

A mobile terminal of the present invention to which a recording medium can be detachably fitted and which can execute contents, includes a directory information acquiring unit for acquiring directory information recorded on the fitted recording medium; a directory deciding unit for deciding whether or not a predetermined particular directory name is contained in the acquired directory information; and a contents setting unit for setting the contents, which is contained in the contents recorded in the recording medium and having the particular directory name, to an executable state if the particular directory name is contained in the acquired directory information.

According to the above configuration, the directory deciding unit for deciding whether or not the predetermined particular directory name is contained in the acquired directory information is provided. Therefore, when the directory that records the contents and has the particular directory name is present, the contents can be set easily to its executable state.

The mobile terminal of the present invention further includes a detecting unit for detecting that the recording medium is fitted; and wherein, if the detecting unit detects that the recording medium is fitted, the directory deciding unit decides whether or not the particular directory name is contained in the acquired directory information.

According to the above configuration, since it is detected that the recording medium is fitted, the directory name can be decided every time when the fitting is detected, and the contents can be easily changed each time.

Also, in the mobile terminal of the present invention, if a same type of contents is contained in plural in the directory having the particular directory name in the recording medium, the contents setting unit set a plurality of contents to the executable state in predetermined order one by one. Also, the mobile terminal of the present invention further includes a selecting unit for selecting the contents; and wherein, if a same type of contents is contained in plural in the directory having the particular directory name in the recording medium, the contents setting unit sets the selected contents to the executable state.

According to the above configuration, even when the same type of contents is present in plural in the directory having the particular directory name, a desired contents can be set easily to its executable state.

Also, in the mobile terminal of the present invention, if a contents changing time setting file that decides previously a contents changing time is present in the directory having the particular directory name in the recording medium, the contents setting unit sets the contents contained in the directory to the executable state at a changing time decided in the contents changing time setting file. In addition, the mobile terminal of the present invention further includes a number-of-incoming calls counting unit for counting a number of incoming calls; and wherein, if a changing time setting file that decides previously to change the contents when the mobile terminal receives the incoming call by a predetermined number of times is present in the directory having the particular directory name in the recording medium, the contents setting unit sets the contents contained in the directory to the executable state when the mobile terminal receives the incoming call by the predetermined number of times.

According to the above configuration, the contents can be changed at a predetermined timing once the recording medium is fitted.

### ADVANTAGE OF THE INVENTION

According to the present invention, the directory deciding unit for deciding whether or not the predetermined particular directory name is contained in the acquired directory information is provided. Therefore, when the directory that records the contents and has the particular directory name is present, the contents can be set easily to its executable state.

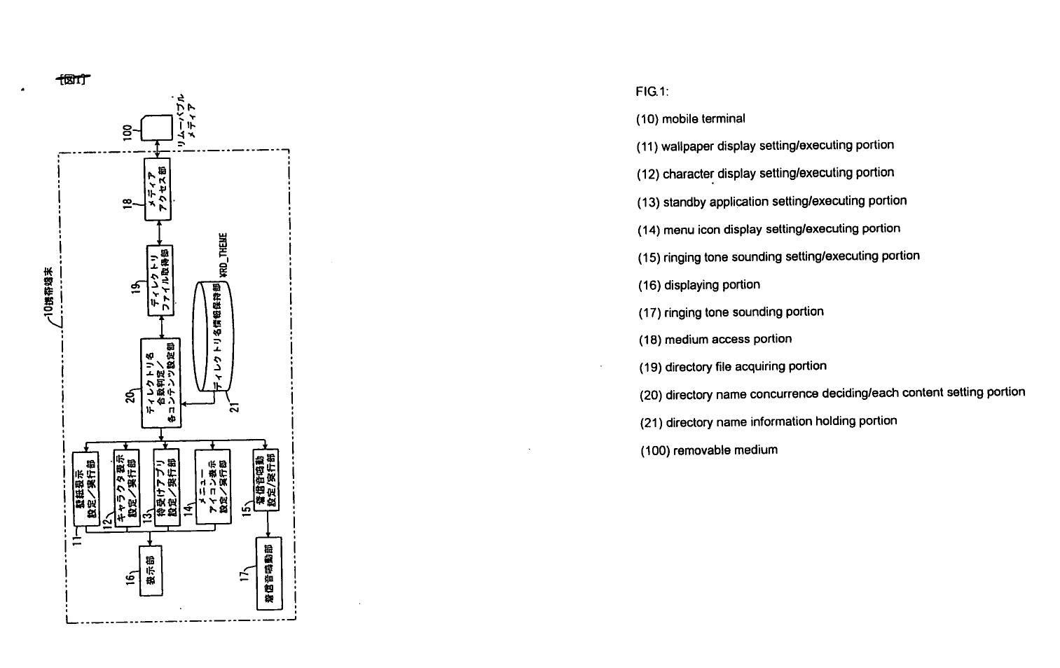

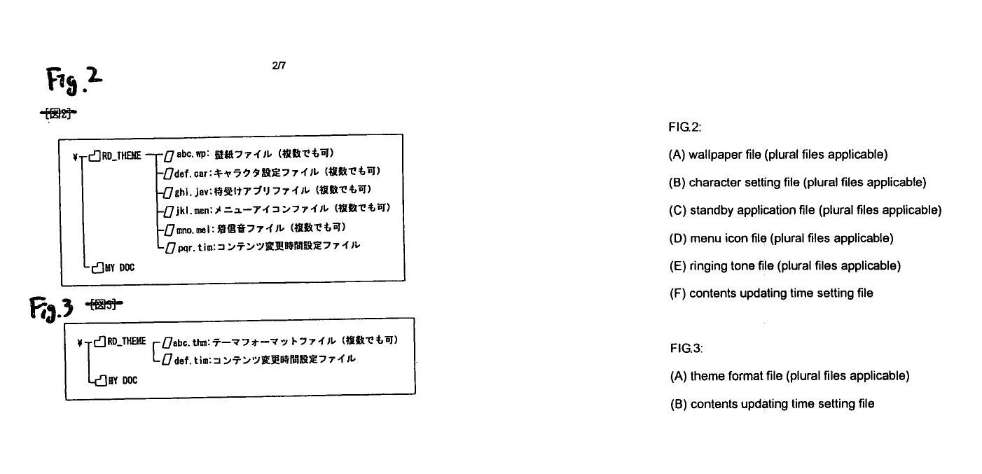

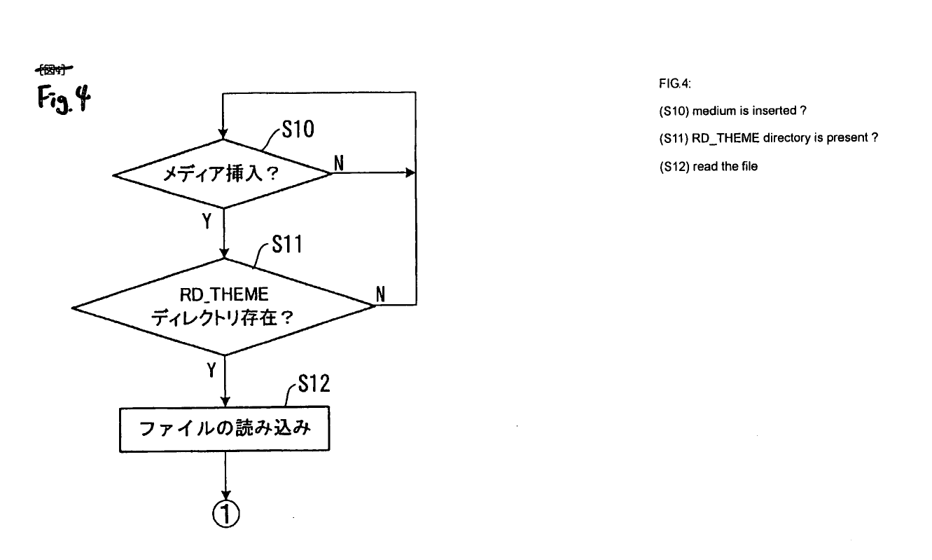

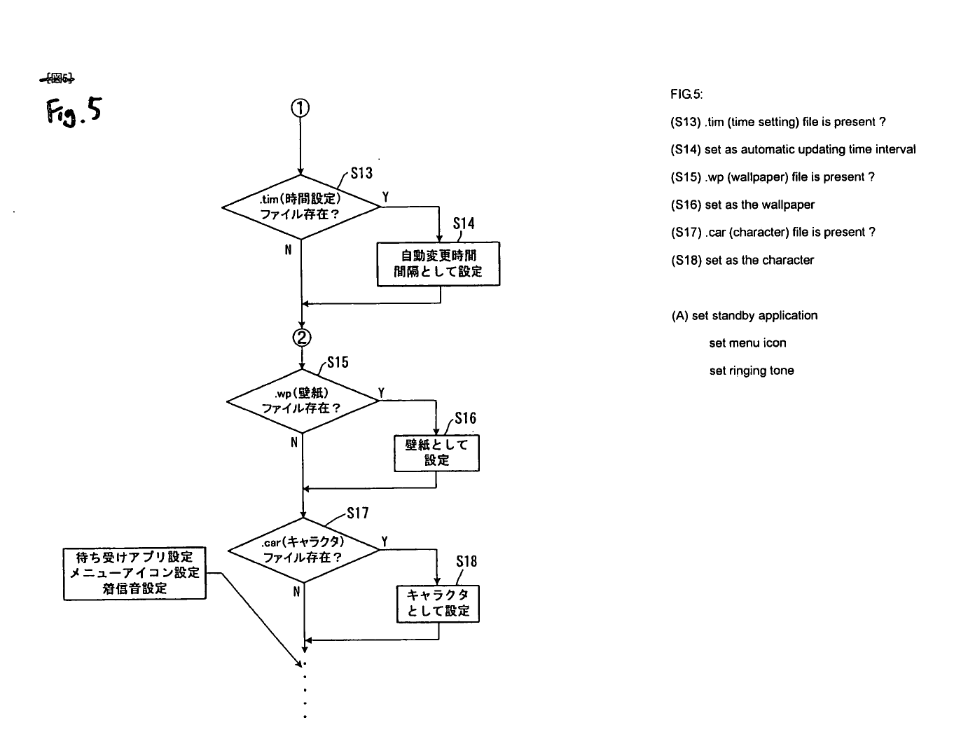

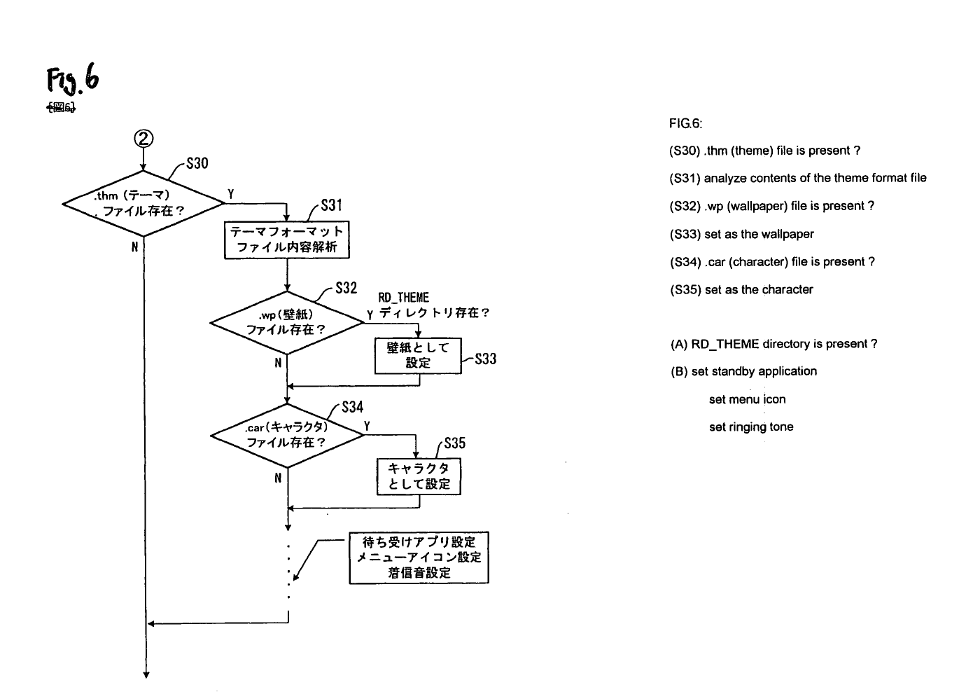

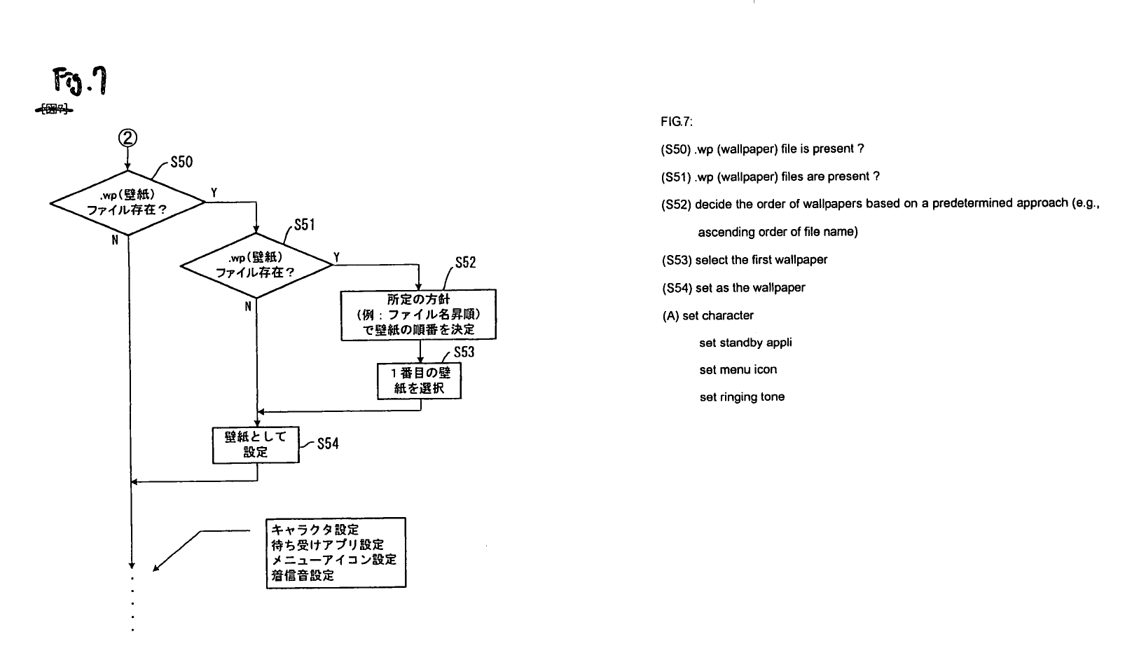

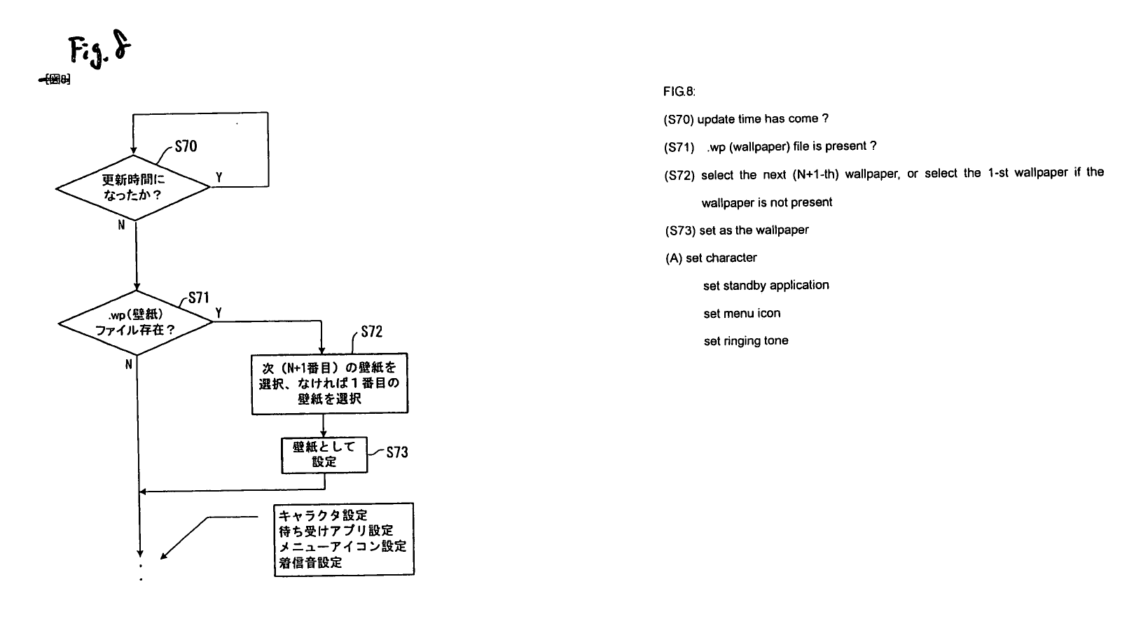

### BRIEF DESCRIPTION OF THE DRAWINGS

[FIG. 1] A block diagram showing functions of a mobile terminal to explain an embodiment of the present invention.

[FIG. 2] A view showing an example of respective contents.

[FIG. 3] A view showing an example of a theme format file.

[FIG. 4] A flowchart showing an operation taken upon inserting a removable medium.

[FIG. 5] A flowchart showing a basic contents processing operation.

[FIG. 6] A flowchart showing a contents processing operation applied to the theme format file.

[FIG. 7] A flowchart showing an operation taken when plural types of same files are provided.

[FIG. 8] A flowchart showing an operation taken when a contents changing time is set.

### DESCRIPTION OF REFERENCE NUMERALS

10 mobile terminal
11 wallpaper display setting/executing portion
12 character display setting/executing portion
13 standby application setting/executing portion
14 menu icon display setting/executing portion
15 ringing tone sounding setting/executing portion
16 displaying portion
17 ringing tone sounding portion
18 medium access portion
19 directory file acquiring portion
20 directory name concurrence deciding/each content setting portion
21 directory name information holding portion
100 removable medium

### BEST MODE FOR CARRYING OUT THE INVENTION

FIG. 1 is a block diagram showing functions of a mobile terminal to explain an embodiment of the present invention, and shows functions of a contents processing portion. In this case, an explanation of respective portions that execute basic processes of the mobile terminal such as making a phone call, receiving a phone call, talking on the phone, etc. will be omitted herein.

A mobile terminal 10 to which a removable medium (recording medium) 100 such as a memory card, or the like is detachably attached, and which can read files of various contents such as “wallpaper”, “character”, “standby application”, “menu icon”, “ringing tone”, etc., which are recorded on the removable medium 100, and sets and executes them. As a configuration for that purpose, the mobile terminal 10 includes a wallpaper display setting/executing portion 11, a character display setting/executing portion 12, a standby application setting/executing portion 13, a menu icon display setting/executing portion 14, a ringing tone sounding setting/executing portion 15, a displaying portion 16, a ringing tone sounding portion 17, a medium access portion 18 for detecting the fact that the removable medium 100 is attached to a main body of the mobile terminal 10, a directory file acquiring portion 19 for acquiring directory information recorded on the fitted removable medium 100, a directory name concurrence deciding/each content setting portion 20, and a directory name information holding portion 21 for holding information of a predetermined particular directory name. The directory name concurrence deciding/each content setting portion 20 decides whether or not the predetermined particular directory name is contained in the directory information acquired by the directory file acquiring portion 19. Then, when the particular directory name is contained in the directory information acquired by the directory file acquiring portion 19, the directory name concurrence deciding/each content setting portion 20 sets the contents contained in the directory with the particular directory name recorded in the removable medium 100 to its executable state.

The medium access portion 18 detects whether or not the removable medium 100 is attached to the main body of the mobile terminal 10. Then, when the medium access portion 18 has detected attachment of the removable medium 100, the medium access portion 18 reads data recorded on the removable medium 100. In the mobile terminal 10 of the present embodiment, since a file management is carried out based on a hierarchical structure, the files are recorded in the removable medium 100 using the hierarchical structure to meet to such file management.

FIG. 2 is a view showing an example of respective contents, and FIG. 3 is a view showing an example of a theme format file. FIG. 2 and FIG. 3 show an example of the contents file recorded in the removable medium 100 respectively. In FIG. 2, a wallpaper file with an extension “.wp”, a character setting file with an extension “.car”, a standby application file with an extension “.jav”, a menu icon file with an extension “.men”, a ringing tone file with an extension “.mel”, and a contents changing time setting file with an extension “.tim” are contained in a directory a directory name of which is ¥RD_THEME. In contrast, in FIG. 3, a theme format file with an extension “.thm” and a contents changing time setting file with an extension “.tim” are contained in a directory a directory name of which is ¥RD_THEME.

Here, the theme format file denotes such a file that a group of contents files such as “wallpaper”, “character setting”, “standby application”, “menu icon”, “ringing tone (melody, voice, song, and the like reproduced in receiving the call)”, etc. are combined in compliance with a format whose specifications are decided previously. Also, the contents changing time setting file denotes an updating defining file that updates the contents in these files every predetermined time when a plurality of contents files or theme format files are present in the predetermined directory.

The directory name concurrence deciding/each content setting portion 20 described later sets various contents contained in a new file executably in the wallpaper display setting/executing portion 11, the character display setting/executing portion 12, the standby appli setting/executing portion 13, the menu icon display setting/executing portion 14, and the ringing tone sounding setting/executing portion 15 every predetermined time according to the contents changing time setting file. In this case, all the contents are not changed, and the contents is never updated when only a single contents file or theme format file is contained in the predetermined directory.

Returning to FIG. 1, the directory file acquiring portion 19 acquires the file containing the directory name information recorded in the removable medium 100. For example, such portion 19 acquires the file containing the directory name information such as above ¥RD_THEME, or the like. The directory name concurrence deciding/each content setting portion 20 decides whether or not the directory name that agrees with the directory name held by the directory name information holding portion 21 is contained in the directory name acquired by the directory file acquiring portion 19. If such directory name is contained, the directory name concurrence deciding/each content setting portion 20 instructs respective setting/executing portions 11 to 15 to set executably respective contents, based on the file contents in the concerned directory acquired by the directory file acquiring portion 19.

In this case, in the directory having the directory name ¥RD_THEME shown in FIG. 2, the “wallpaper file”, the “character setting file”, the “standby application file”, the “menu icon file”, and the “ringing tone file” are contained. Therefore, the “wallpaper file” is transferred to the wallpaper display setting/executing portion 11, the “character setting file” is transferred to the character display setting/executing portion 12, the “standby application file” is transferred to the standby application setting/executing portion 13, the “menu icon file” is transferred to the menu icon display setting/executing portion 14, and the “ringing tone file” is transferred to the ringing tone sounding setting/executing portion 15, and then respective setting/executing portions 11 to 15 set executably respective contents.

Also, when the theme format file is contained in the directory whose directory name is ¥RD_THEME, such theme format file is separated into the “wallpaper file”, the “character setting file”, the “standby appli file”, the “menu icon file”, the “ringing tone file”, and the like in compliance with the format whose specifications are decided previously by the directory name concurrence deciding/each content setting portion 20. Various contents in the theme format file, i.e., “wallpaper”, “character setting”, “standby application”, “menu icon”, and “ringing tone”, are set executably by the wallpaper display setting/executing portion 11, the character display setting/executing portion 12, the standby application setting/executing portion 13, the menu icon display setting/executing portion 14, and the ringing tone sounding setting/executing portion 15 respectively.

The wallpaper display setting/executing portion 11, the character display setting/executing portion 12, the standby application setting/executing portion 13, the menu icon display setting/executing portion 14, the ringing tone sounding setting/executing portion 15, the displaying portion 16, and the ringing tone sounding portion 17 are installed into the conventional mobile phone. These setting/executing portions carry out display of the wallpaper, display of the character, display of the moving picture obtained by the standby application, display of the menu icon, and sounding of the ringtone melody respectively.

FIG. 4 is a flowchart showing an operation taken upon inserting a removable medium, FIG. 5 is a flowchart showing a basic contents processing operation, FIG. 6 is a flowchart showing a contents processing operation applied to the theme format file, FIG. 7 is a flowchart showing an operation taken when plural types of same files are provided, and FIG. 8 is a flowchart showing an operation taken when a contents changing time is set.

[Insertion of the Removable Medium]

In FIG. 4, first, it is decided whether or not the removable medium 100 is fitted and, if the medium is not fitted, this process is repeated until the medium is fitted (step S10). If the removable medium 100 is fitted, the data recorded on the removable medium 100 are read. Then, it is decided whether or not the directory whose directory name is ¥RD_THEME is present (step S11). In this decision, if the directory whose directory name is ¥RD_THEME is not present, the process goes back to step S10. In contrast, if the directory having the directory name ¥RD_THEME is present, the contents files contained in the directory are read (step S12). The above processes are executed by the medium access portion 18 and the directory file acquiring portion 19.

[Basic Process]

In FIG. 5, first, it is decided whether or not the contents changing time setting file with the extension “.tim” is present in the directory having a particular directory name in the file read in the preceding process (step S13). In this decision, if the contents changing (updating) time setting file with the extension “.tim” is present, a time designated by the file, i.e., an automatically-changed time interval, is set (step S14). If the contents changing time setting file with the extension “.tim” is not present, a default automatically-changed time interval is set under the assumption that the concerned file is present. Then, it is decided whether or not the wallpaper file with the extension “.wp” is present (step S15). In this case, the default automatically-changed time interval may be set previously by the user.

If the wallpaper file with the extension “.wp” is present, the wallpaper display setting/executing portion 11 is instructed to set executably the file (step S16). If the wallpaper file with the extension “.wp” is not present, the process goes to next step. In next step (step S17), it is decided whether or not the character setting file with the extension “.car” is present in the same file. In this decision, if the character setting file with the extension “.car” is present, the character display setting/executing portion 12 is instructed to set executably the file (step S18). In contrast, the character setting file with the extension “.car” is not present, the process goes to next step. In next step et seq., the processes similar to the above wallpaper setting and character setting processes are executed in order of the standby application setting, the menu icon setting, and the ringing tone setting. The above processes are carried out by the directory name concurrence deciding/each content setting portion 20.

[Contents Processing Operation Applied to the Theme Format File]

In FIG. 6, first, it is decided whether or not the theme format file with the extension “.thm” is present in the directory having a particular directory name in the file read in the preceding process (step S30). In this decision, if the theme format file with the extension “.thm” is present, contents of the theme format file are analyzed (step S31).

Based on the analyzed result of the contents of the theme format file, it is decided whether or not the wallpaper file with the extension “.wp” is contained in the theme format file (step S32). In this decision, if the wallpaper file with the extension “.wp” is contained, the wallpaper display setting/executing portion 11 is instructed to set executably the file (step S33). In contrast, if the wallpaper file with the extension “.wp” is not contained, the process goes to next step.

In next step (step S34), it is decided whether or not the character setting file with the extension “.car” is present in the same file. If the character setting file with the extension “.car” is present, the character display setting/executing portion 12 is instructed to set executably the file (step S35). In contrast, if the character setting file with the extension “.car” is not present, the process goes to next step. In next step et seq., the processes similar to the above wallpaper setting and character setting processes are executed in order of the standby application setting, the menu icon setting, and the ringing tone setting. The foregoing processes are carried out by the directory name concurrence deciding/each content setting portion 20.

[Operation Taken when Plural Types of Same Files are Provided]

In FIG. 7, it is decided whether or not the wallpaper file with the extension “.wp” is contained in the directory which is read by the process in step S12 and whose directory name is ¥RD_THEME (step S50). In this decision, if the wallpaper file with the extension “.wp” is contained, it is decided whether or not a plurality of wallpaper files with the extension “.wp” are present (step S51). If a plurality of wallpaper files with the extension “.wp” are present, the order of wallpapers is decided based on a predetermined approach (step S52). For example, the order is decided in ascending order of the file name.

Then, the first wallpaper is selected (step S53). Then, the file is set in the wallpaper display setting/executing portion 11 (step S54). After this process is ended or if the wallpaper file with the extension “.wp” is not present, the process goes to next step. In next step et seq., the processes similar to the above wallpaper setting are executed in order of the character setting, the standby application setting, the menu icon setting, and the ringing tone setting. The above processes are carried out by the directory name concurrence deciding/each content setting portion 20.

[Automatic Updating Process]

In FIG. 8, when the automatically-changed time interval is set in steps S13 and S14 in the basic process, first it is decided whether or not an update time has come (step S70). In this decision, if the update time has not come, this process is repeated. In contrast, if the update time has come, the process goes to next step. In next step (step S71), it is decided whether or not the wallpaper file with the extension “.wp” is present (step S72). Then, the next (N+1-th) wallpaper is selected if the wallpaper file with the extension “.wp” is present, or the 1-st wallpaper is selected if the wallpaper is not present (step S73). Then, the wallpaper display setting/executing portion 11 is instructed to set executably the selected wallpaper file (step S74).

If the process of setting the new wallpaper is executed or the wallpaper file with the extension “.wp” is not present, the process goes to next step. In next step et seq., the processes similar to the above wallpaper automatically changing process are executed in order of the character setting, the standby application setting, the menu icon setting, and the ringing tone setting. The above processes are carried out by the directory name concurrence deciding/each content setting portion 20.

In this manner, according to the mobile terminal 10, the recorded directory information are acquired when the removable medium 100 is fitted, and then it is decided whether or not the predetermined particular directory name is contained. Then, if the particular directory name is contained, the contents file contained in the directory is read. Then, the wallpaper display setting/executing portion 11, the character display setting/executing portion 12, the standby application setting/executing portion 13, the menu icon display setting/executing portion 14, the ringing tone sounding setting/executing portion 15 set executably each contents file, based on the extension of the contents file respectively.

Accordingly, respective contents are automatically set executably only by fitting the removable medium 100, in which the contents such as the wallpaper, the character, the standby application, the menu icon, the ringing tone, and the like are recorded, to the mobile terminal 10. Therefore, the user can change easily the contents without operation of the mobile terminal 10 itself.

Also, when the same type of contents is contained in plural in the directory having the particular directory name, these contents can be set to their executable state in predetermined order one by one. For example, when a plurality of ringtone melodies are contained, these melodies can be reproduced in predetermined order.

Also, when the contents changing time setting file for deciding the changing time of the contents is present in the directory having the particular directory name, the contents to be executed is changed in accordance with the changed time interval decided in this file. At this time, the changing time of the particular contents may be described in the contents changing time setting file, and then the contents contained in the directory having the particular directory name may be set to its executable state when the changing time has come. Thus, when the contents changing time setting file indicating that the contents should be changed at 12:00, for example, is present, the change of the setting of the contents is executed at that time.

Also, as a contents setting timing, for example, the number of incoming calls may be counted and then the setting of the contents may be updated at a point of time when the number of incoming calls reaches a predetermined number. In this case, a number-of-incoming calls counting unit for counting the number of incoming calls is needed, but the number-of-incoming calls counting unit can be realized easily by counting the signal that is obtained when the call comes in. Moreover, various events can be used as the contents changing timing.

In the above embodiment, when the same type of contents is contained in plural in the directory having the particular directory name, the reproducing order is decided according to the predetermined approach. In this event, the user may decide arbitrarily the order, or the user may select the desired contents as many as he or she can. Further, when the user selects two contents or more, the user may decide the reproducing order as he or she wishes. In this case, in order to make it possible for the user to select freely the reproducing order, a structure used for that purpose is required. For example, such structure can be accomplished by providing a display controlling portion (not shown) which has a function of causing the displaying portion 16 to display the same type of contents thereon and an inputting portion (not shown) by which the user can designate the desired one from the same type of displayed contents. As a result, when a plurality of ringtone melodies are provided, for example, the user can choose the desired one among them, and the user can change the setting of the ringtone melody in desired order.

The present invention is explained in detail with reference to the particular embodiment. But it is apparent for those skilled in the art that various variations and modifications can be applied without departing from a spirit and a scope of the present invention.

This application is based upon Japanese Patent Application (Patent Application No. 2004-007972) filed on Jan. 15, 2004, the contents of which are incorporated herein by reference.

### INDUSTRIAL APPLICABILITY

The mobile terminal of the present invention has such an effect that the contents can be set easily in its executable mode, and is serviceable for the mobile terminal that is capable of executing the contents, and the like.

1. A mobile terminal which is adapted to detachably fit a recording medium and which is operable to execute contents, comprising:
a directory information acquiring unit that acquires directory information recorded on the fitted recording medium;
a directory deciding unit decides whether a predetermined particular directory name is contained in the acquired directory information; and
a contents setting unit that sets the contents, which is contained in a directory having the particular directory name and recorded on the recording medium, to an executable state when the particular directory name is contained in the acquired directory information.

2. The mobile terminal according to claim 1, further comprising:
a detecting unit that detects that the recording medium is fitted, and
wherein, the directory deciding unit decides whether the particular directory name is contained in the acquired directory information when the detecting unit detects that the recording medium is fitted.

3. The mobile terminal according to claim 1, wherein the contents setting unit set a plurality of contents to the executable state in predetermined order one by one when a plurality of the same type of contents are contained in the directory having the particular directory name in the recording medium.

4. The mobile terminal according to claim 1, further comprising:
a selecting unit that selects the contents, and
wherein, when a plurality of the same type of contents are contained in the directory having the particular directory name in the recording medium, the contents setting unit sets the selected contents to the executable state.

5. The mobile terminal according to claim 1, wherein, when a changing time setting file which defines previously a contents changing time is present in the directory having the particular directory name in the recording medium, the contents setting unit sets the contents contained in the directory to the executable state at a changing time defined in the changing time setting file.

6. The mobile terminal according to claim 1, further comprising:
a number-of-incoming calls counting unit that counts a number of incoming calls; and
wherein, when a changing time setting file that defines previously to change the contents in a case that the mobile terminal receives the incoming call by a predetermined number of times is present in the directory having the particular directory name in the recording medium, the contents setting unit sets the contents contained in the directory to the executable state when the mobile terminal receives the incoming call by the predetermined number of times.
